(19) United States
(12) Patent Application Publication
(10) Pub. No.: US 2015/0304270 A1
(43) Pub. Date: Oct. 22, 2015

(54) SYSTEM, PROCESS AND COMPUTER WRITEABLE MEDIUM FOR PROVIDING A SOCIAL MEDIA DIRECTED MOBILE APPLICATION HAVING INQUIRY BASED GAME PLAY FUNCTIONALITY

(71) Applicant: Claudia Cook, Sterling Heights, MI (US)

(72) Inventor: Claudia Cook, Sterling Heights, MI (US)

(21) Appl. No.: 14/692,386

(22) Filed: Apr. 21, 2015

Related U.S. Application Data
(60) Provisional application No. 61/982,602, filed on Apr. 22, 2014.

(51) Int. Cl. H04L 12/58; H04L 29/06

(52) U.S. Cl. CPC H04L 51/32; H04L 65/403

(57) ABSTRACT

A social media based messaging and entertainment system incorporating any number of processor driven devices, each including key input and audio/visual output display features. A software program incorporated into the processor device further includes a plurality of enterable fields for composing and responding to query based messages. The software program further may include any of a browser supported website or a mobile operating system supported application configured for linking together any number of the processor driven devices.

### CROSS-REFERENCE TO RELATED APPLICATIONS

This Application claims the benefit of U.S. Provisional Application 61/982,602 filed on Apr. 22, 2014, the contents of which are incorporated herein in its entirety.

### FIELD OF THE INVENTION

The present invention discloses a mobile application which incorporates various aspects of social media and audio-visual input (including any or all of video, pictorial, audial and textual information), in order to provide a game play version of a social media network for any number of participants and which is based on a series of questions, clues and answers.

### BACKGROUND OF THE INVENTION

The prior art is well documented with examples of social media based game play systems and related computer writeable/algorithmic media. A first example of this is set forth in U.S. 2014/0011594 to Diaz which teaches an electronic social trivia network system that allows multiple parties to engage in matches of trivia contests from remote locations. The social network further permits electronic trivia access without the need for specific hardware. The network also provides means for participants to author questions and host trivia games. A related software program or “app,” designed for at personal computing or communications devices is downloadable to be installable on multiple hardware platforms therefore eliminating the need for dedicated trivia hardware. Participants in the social trivia network can chat, play trivia, create games, join games, and maintain game records.

U.S. 2013/0267287, to Goldenberg, teaches a system and method for playing an interactive song lyric guessing game. Some aspects present a player with a scrambled word cloud of lyrics and asks the player to select the correct name of the artist or song from a list of possible answers. Advertising and other commercially useful information are presented to the user and collected from the user in the course of playing the game. For example, the player of the game may be directed to an online store where songs can be purchased or downloaded.

U.S. 2012/0178536, to Oh et al., relates to a method for inviting smartphone users to a game for smartphones using a social network among the smartphone users. According to the present invention, a user may invite another user to a game through a chat window, and thus it is possible to simply play a game together.

U.S. Pat. No. 6,981,223, to Becker et al, discloses a graphical user interface displaying a unique graphical indexing element such as a tab for each engaged and non-engaged messaging session. The user chooses which messaging session to make engaged by selecting its graphical indexing element. The graphical indexing elements have various distinctive characteristics to indicate the status of their respective messaging sessions, such as engaged, non-engaged with no unread messages, or non-engaged with at least one unread message. The messaging sessions may all be docked, in which event the engaged messaging session is displayed in a window pane set and the other messaging sessions are not displayed, or may be selectively undocked, in which event the engaged messaging session and the undocked messaging sessions are displayed in respective window pane sets. The engaged window pane set supports the communication of original or predefined messages between the user's digital device and the pal's messaging-enabled digital device, regardless of capability.

U.S. Pat. No. 7,240,093, to Danieli et al., teaches a method and system facilitating selection of participants in multiplayer online electronic games. The method provides an efficient procedure for players to host and join new instances of multiplayer online electronic games, as well as providing a scheme that enables players to join multiplayer online electronic games that are already in progress. The method is implemented through a gaming utility that runs on each player's electronic device (e.g. PC) and interacts behind the scenes with an online messaging service. Player hosts are enabled to select players from a list of contacts provided by the online messaging service who they want to invite to join a chat session. A selected multiplayer online electronic game is selectively launched on all of the player's computers through a single command issued by the host. Additionally, the gaming utility provides players with a list of existing chat sessions being hosted by other players so as to enable the players to join multiplayer online electronic games that are already in progress. The system includes a plurality of electronic devices linked in communication across a communications network, such as a LAN or the Internet. Each electronic device is operatively coupled to a headset having a pair of headphones and a microphone. The headset is worn by a player, enabling the players to verbally communicate with others in a verbal chat session.

U.S. Pat. No. 7,549,924, to Canessa et al., teaches an instant messaging system and method which allows users to play competitive and collaborative games using an instant messaging client application. The client application may create a user interface screen that includes an instant messaging region or window for exchanging instant messages and a game region or window for playing games.

Finally, U.S. 2012/0021829 to Shoham, disclose a photographic social game. The photographic social game may be played using, for example, camera-enabled devices (e.g., participating devices). The photographic social game may prompt users of camera-enabled devices to take and submit photographs at a particular time (e.g., 5:00 PM GMT or 5:00 PM local time), after occurrence of a particular event (e.g., 5 minutes after waking up), or any suitable combination thereof. These photos may be assembled by the game machine into a presentation that is shared among the users participating in the photographic social game, and one or more of various games may be played by the users based on the presentation.

### SUMMARY OF THE INVENTION

The present invention discloses a social media based messaging and entertainment system incorporating any number of processor driven devices, each including key input and audio/visual output display features. A software program incorporated into the processor device further includes a plurality of enterable fields for composing and responding to query based messages. The software program further may include any of a browser supported website or a mobile operating system supported application configured for linking together any number of the processor driven devices.

A related computer writeable medium is also disclosed for use with the social media based messaging and entertainment system and includes software program in use with the processor driven device which presents a number of subroutines including a first subroutine for presenting a plurality of secure user enterable fields for creating a query based message or viewing a previously created message or response and a second subroutine for directing to a targeted group of individuals the message or response, this further including the ability to respond only to the sender or respond to all fields.

The first subroutine may further provide a subset screen display including a plurality of entry fields for adding any one or more of text, pictorial or video inputs to the message or response. Additional features of the computer writeable medium include a third subroutine for linking the program to an existing social media platform, a further subroutine for inputting a rating feature in cooperation with any created or responded query message.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustration of a title screen, such as associated with a mobile application variant of the present invention, which can form one non-limiting application of a social media type game incorporated into such as a mobile application;

FIG. 2 is a succeeding screen illustration associated with a mobile application incorporating the social media game and including both create GuessMessage and View Questions and Responses access fields;

FIG. 3 is a Create New screen display based upon the selected input from FIG. 2 with inputs for creating a message including multi-media input fields further depicted in FIGS. 3A and 3B and rating input field;

FIG. 4 is a choose recipient screen display for compiling and grouping lists of participants of the system;

FIG. 5 is a receipt/response screen display with additional fields for providing text, pictorial or video response;

FIG. 6 is a repetition of the screen of FIG. 2 with a new message or response notification icon;

FIG. 7 a display screen for both received and sent questions and responses along with notification of ratings and any new responses;

FIG. 8 is a display screen depicting a list of messages associated with a given user or group of users;

FIG. 9 is a succeeding user response display screen;

FIGS. 10A and 10B are group and participant list screens;

FIG. 11 is an illustration of a favorites screen display;

FIG. 12 is an all contacts screen display;

FIG. 13 is an add to group screen;

FIG. 14 is a settings screen display;

FIG. 15 is an edit profile screen display;

FIG. 16 is a notification screen display;

FIG. 17 is a help screen display;

FIG. 18 is a privacy and settings screen display; and

FIG. 19 is a media auto download screen display.

### DETAILED DESCRIPTION OF THE PREFERRED EMBODIMENTS

As previously noted, the present invention discloses a media messaging application incorporating aspects of privacy (as to a selected or approved group of users) as well as personal for encouraging sincere responses. Such “gameplay messaging” allows the users to create their own game in a messaging format with any combination of questions, clues and answers.

As will be described in further detail, starter questions can, without limitation, be based around the word “Guess?” and/or the words “What do you think?” Additional features include adding multiple forms of media selected from any or all including photo, video, text, etc.

The mobile application also incorporates various aspects of social media and audio-visual input (including any or all of video, pictorial, audial and textual information), in order to provide a game play version of a social media network for any number of participants and which is based on a series of questions, clues and answers. A system and computer writeable medium provides a novel and unique application (typically mobile however which can be reconfigured for use as well by laptops or PC computers) and which can be modified or reconfigured to permit variations of participatory game play combined with social media aspects.

In overview, the present invention provides examples of text, pictorial, audial/video or combination of inquiries which can form one non-limiting application of a social media type game incorporated into such as a mobile application incorporating a software program providing a series of screen displays for effectuating the objectives of the invention. As will be described in further detail with reference to the succeeding descriptions, the system and computer writeable medium operates under the principle of the individual providing one or more queries to which an answer or guess is requested.

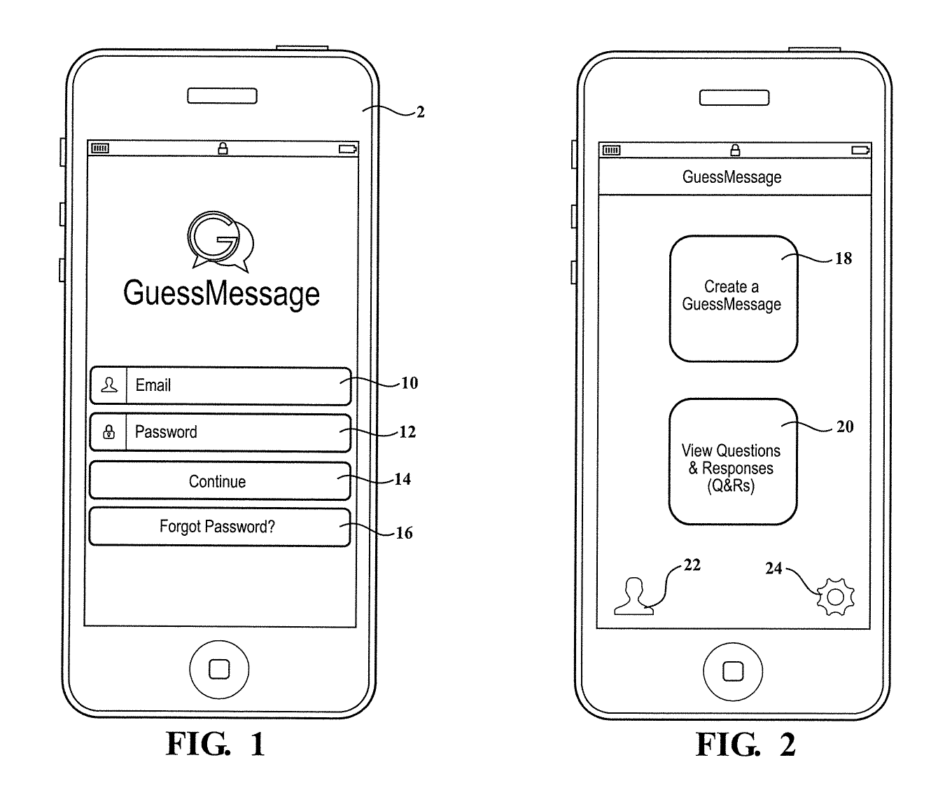

FIG. 1 is an illustration of title screen associated with a physical representation of a processor or computer, such depicted in non-limiting fashion as a smartphone 2, such as associated with a mobile application variant of the present invention, which can form one non-limiting application of a social media type game incorporated into such as a mobile application. The screen display exhibits entry fields for email address 10, password 12, continue 14 or forget password? 16.

As is also understood, the device 2 in FIG. 1 is understood to represent one of any number of processor driven devices, each associated with a given user and which are capable of being communicated to one another by any suitable network connection not limited to cable, fiber optic or, more typically, a wireless form of communication not limited to any of WiFi, Bluetooth or cellular network (3G, 4GLTE, etc). Although not shown, it is further understood that the software associated with the present system and computer writeable medium may also include a central component or module which is contained within a network server and which interfaces with each of the individual user devices 2, such as via the wired or wireless network.

Following initial installation of the application onto the PC device (not limited to a smart phone, tablet, laptop or PC) the user is guided through a protocol for registering with the operators of the mobile application. This can include users creating any or all of a username (with or without picture ID), contact identification through cell phone number, as well as a searchable database within phone embedded contacts for identifying other users of the program.

FIG. 2 is a succeeding screen illustration associated with such as a mobile application incorporating the social media game and including both create GuessMessage 18 and View Questions and Responses 18 access fields. Also depicted are profile 22 and general settings 24 icons.

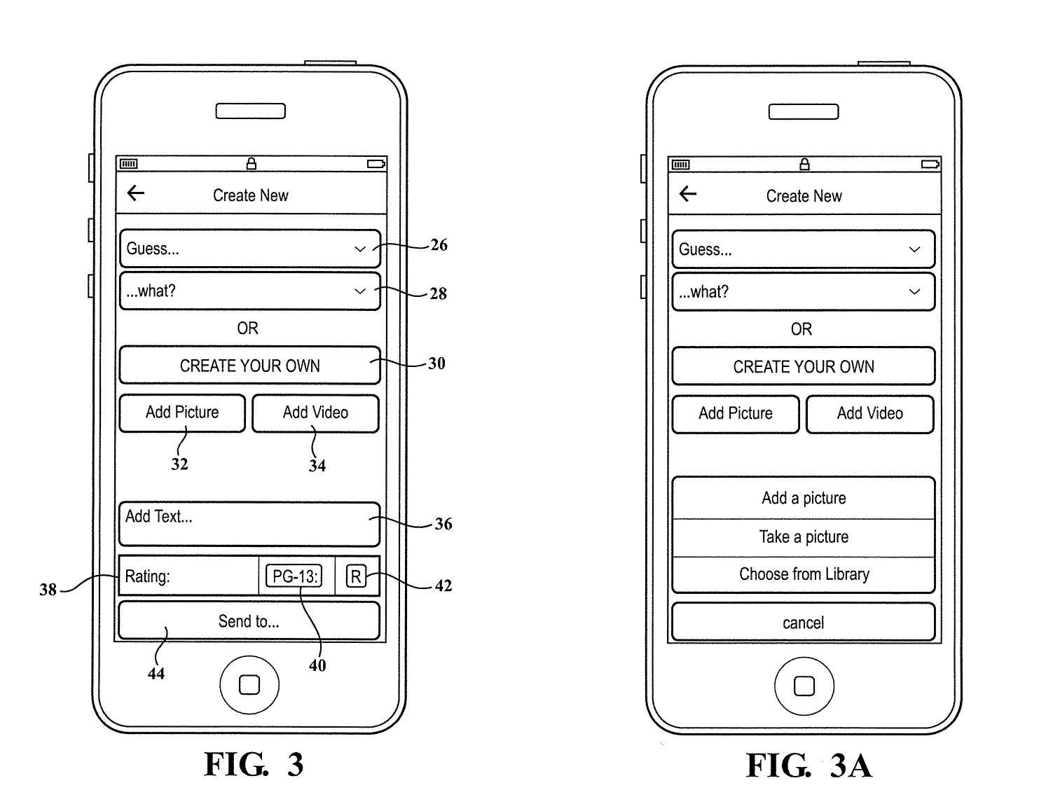

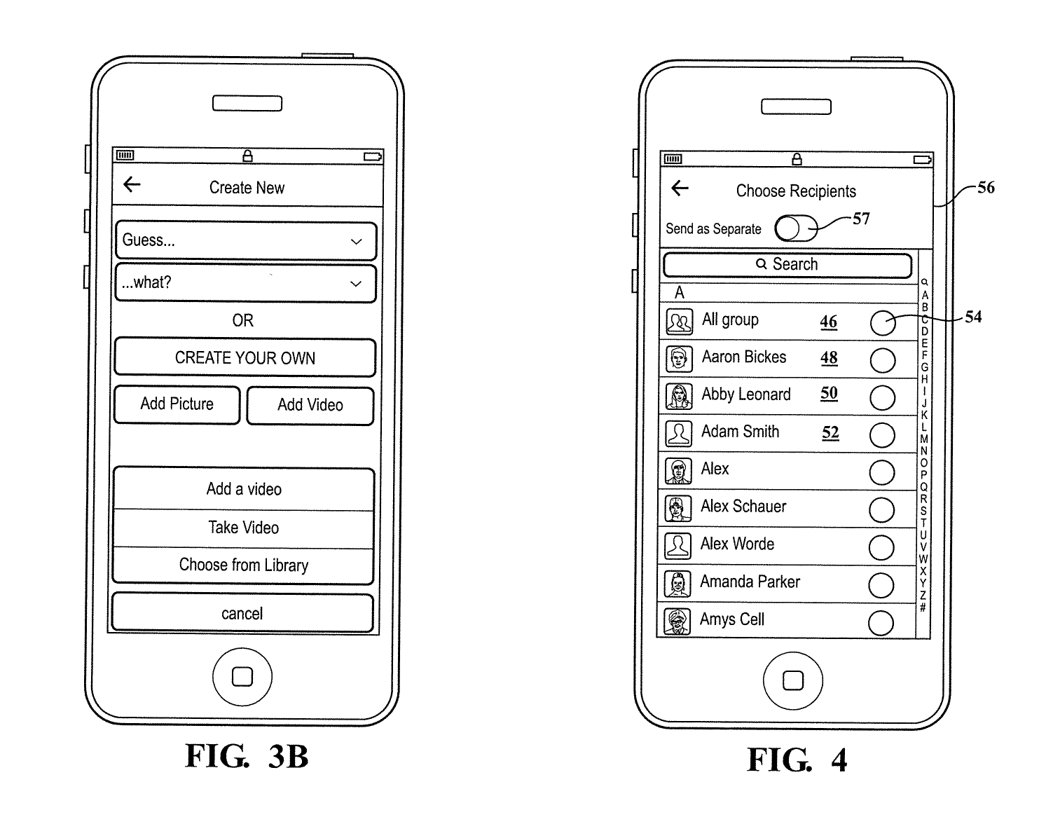

FIG. 3 is a Create New screen display based upon the selected input 18 from FIG. 2. This includes question starter fields for Guess 26 or . . . what? 28. Non-limiting examples of these can include “Guess what I'm doing?”, “Guess who I'm with?”, “Guess what I'm thinking?”, “Guess where I'm at?”, or “What do you think about this?”. The drop down 28 also provides an option to fill it in yourself, allowing the user to create a full question while still using a starter field option. As with each of the screen displays included in the present disclosure, the software operating system of the associated device includes an appropriate keyboard (either physical or drop down) for assisting the user in keying in the appropriate commands or responses.

Alternately, a create your own field 30 is indicated and by which the user can custom enter a query or statement not limited to the preset parameters of fields 26 and 28. This can include such queries as “Does anyone want to go to a concert with me?”, “Where is a good place to eat in LA?”, “Does anyone want to play basketball tonight?”, “Would anyone wear this new line of hats?”, or “I can't wait for the 4^{th} of July weekend!”

An add picture field 32 leads to a drop down menu representation shown in FIG. 3A, and such as can be integrated into a selected software operating system (e.g. Apple iOS or Android). A selected box can be chosen (not shown) to blur the image sent in the message. This image would be blurred and fade to clear timing the amount of time it took for recipients to guess. An add video field 34 likewise proceeds to the drop down menu representation of FIG. 3B associated with the operating software. In this manner, the user can either take a picture or video or can choose an existing file from the library associated with the processor driven device (i.e. smartphone, laptop, tablet computer, desktop PC or the like).

A rate your GuessMessage entry field is further referenced at 38, such further designating PG-13 at 40 or R at 42 settings. The provision of the rating field is beneficial to the system and computer writeable medium in that it allows a user to warn other users as to the likely content of the messages and attachments being circulated, this promoting discretion when viewing. Also depicted at 44 is a send to entry field for choosing which contacts (some or all) to send the message to.

FIG. 4 depicts a choose recipient screen display for compiling and grouping lists of participants of the system. As shown, this can include the user having the ability to place participants (see all group designation 46 or individual user designations 48, 50, 52, et seq.) in groups to use as a distribution list for quick sending to multiple users. As further indicated, a check mark (see for example at 54) appears when choosing each recipient and, once all recipients are chosen, a send button 56 is activated in order to send the message. When multiple recipients are chosen, the sender has the ability to turn a “send as separate” field to ON (see button 57) which will send the same GuessMessage to multiple people separately and not in a group format. This message will be displayed on the Sent Q & Rs list as separate messages to each of the individuals chosen on the recipient list.

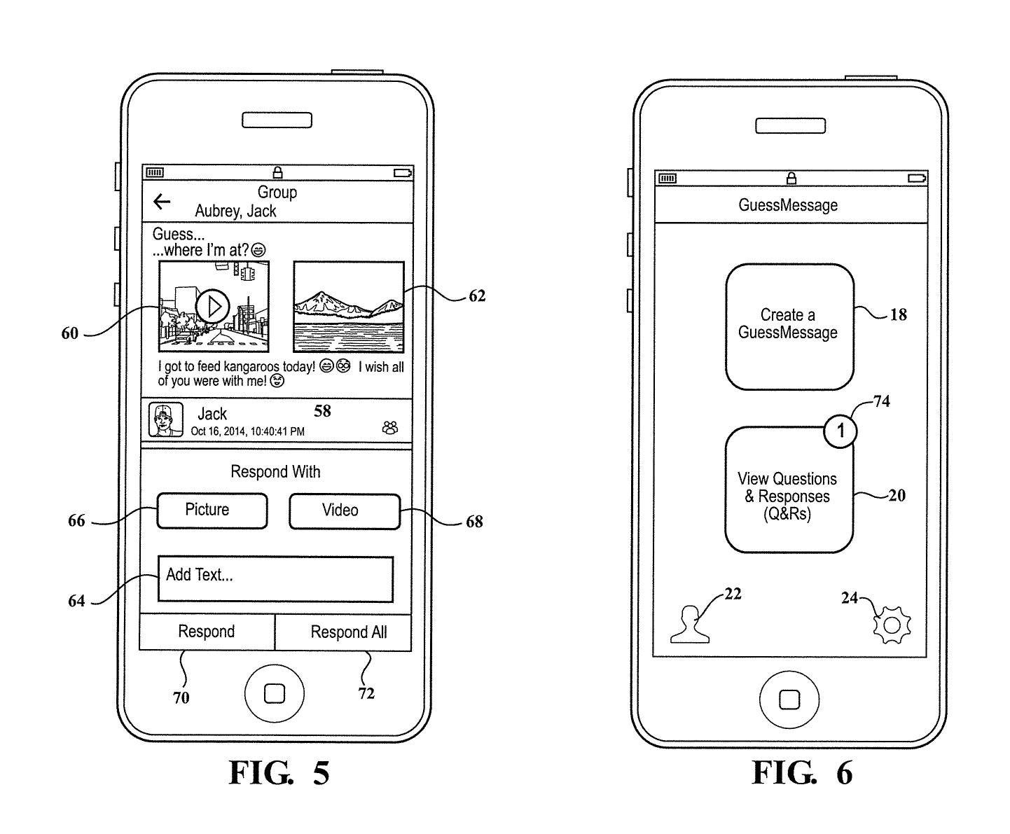

Proceeding to FIG. 5, a receipt/response screen display is shown and including a main field 58 which incorporates the message, at 58 along with any video 60 and/or pictorial 62 files. Additional fields are depicted for providing text, at 64, pictorial, at 66, and/or video, at 68, responses. Also shown are entry fields for responding to the sender only (at 70) or to all (at 72).

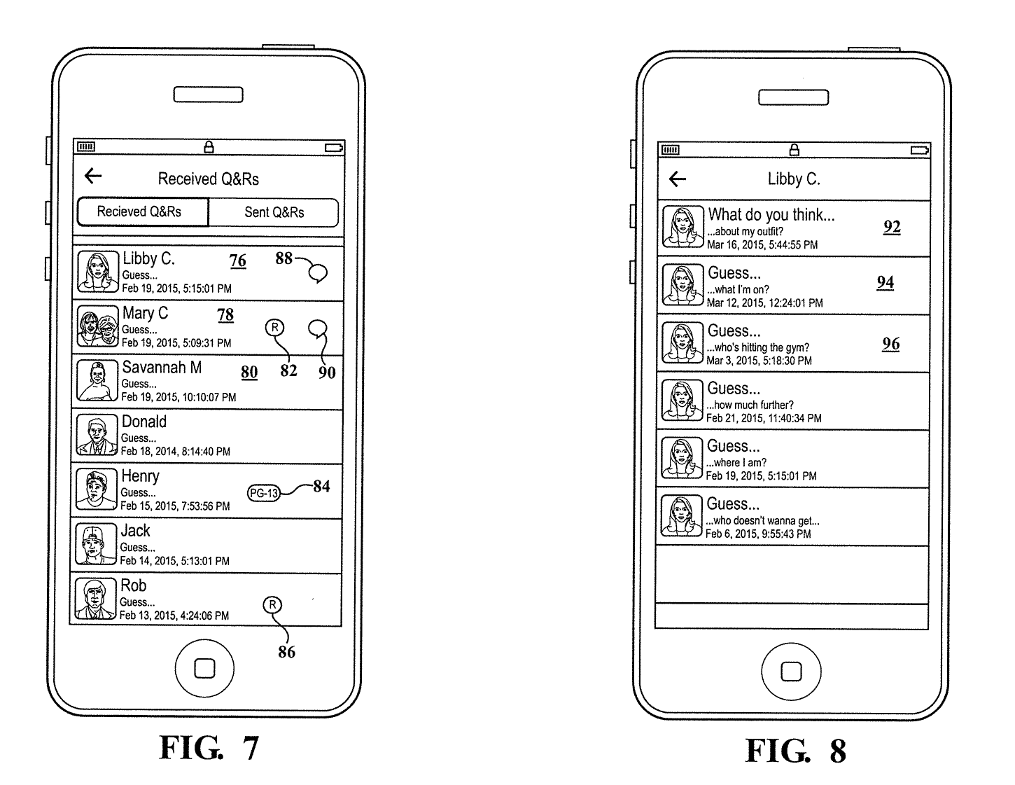

FIG. 6 is a repetition illustration of the main screen of FIG. 2 with a new message or response notification icon 74 for notifying the user if new messages and/or responses have been received. FIG. 7 presents a received and sent questions a display screen for both received and sent questions and responses, along with notification of ratings and any new responses. Reference is made to user identities 76, 78, 80, et seq. along with rating icons 82, 84, 86 et seq. as well as new response icons 88 and 90. In this manner, the user can view messages which have been sent to him/her, messages they have sent out, as well as tracking the timeline of an initial starter questions and responses which is displayed with the most recent on top along with notifications of any relevant ratings and new responses from within the designated group.

FIG. 8 is a display screen depicting a list of messages 92, 94, 96, et seq., associated with a given user or group of users. In this fashion, and upon the user clicking on a selected one of the individual or group of users, the software directs the user to a list of messages associated with (originated or participated in) that specified user or group(s) of users.

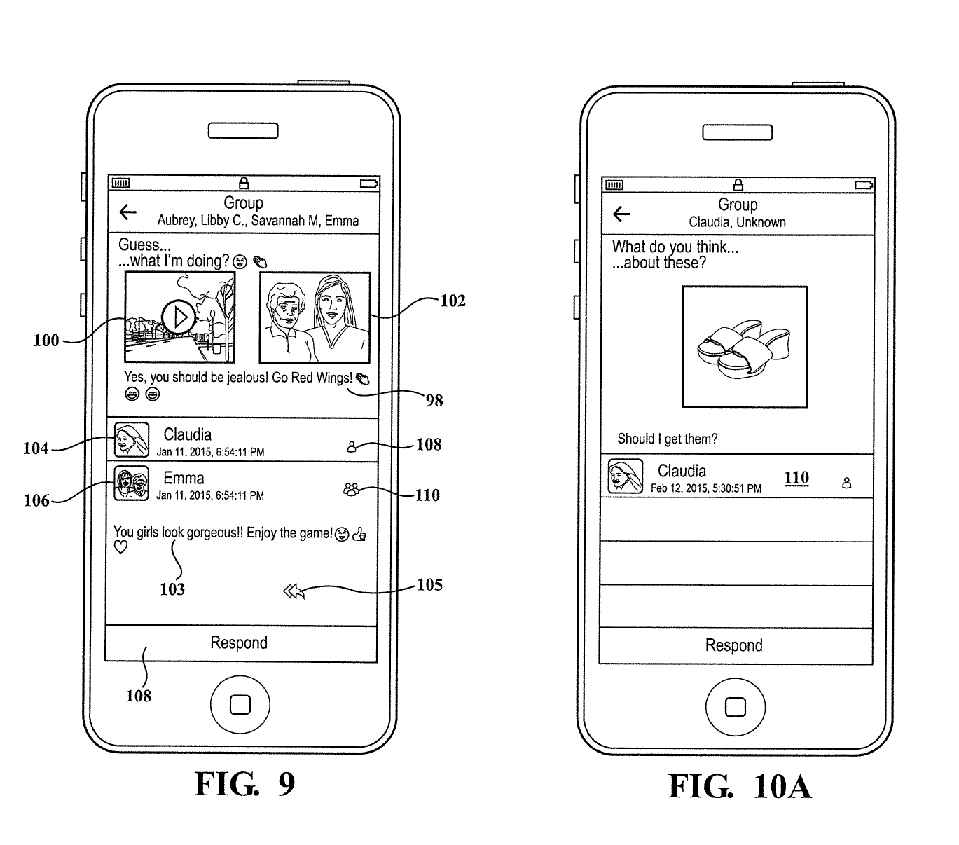

FIG. 9 is a succeeding user response display screen which includes message and file screens similar to that shown at 58, 60 and 62 in related group screen of FIG. 5. User responses are further depicted at 103 for individuals 104 and 106 and, along with the initial message being continuously displayed, the most recent responses are listed. Additional icons, such as single head 108 for user 104, indicate a response tailored for receipt by that individual only, whereas triple head icon 110 for user 106 indicates that the response was transmitted to everyone within the group. A double arrow icon 105 is displayed under each user's response. This allows the user to click the double arrow and respond just back to that person thus displaying the single head icon. This leads to the ability (not shown) to select some of recipients to respond to. Personalizing your response even further to respond to one, respond to some, and/or respond to all. When a user the triple head icon is shown and the message is expanded; underneath the time will show a list of names that the response was received by (not shown). A respond field is also designated at 108.

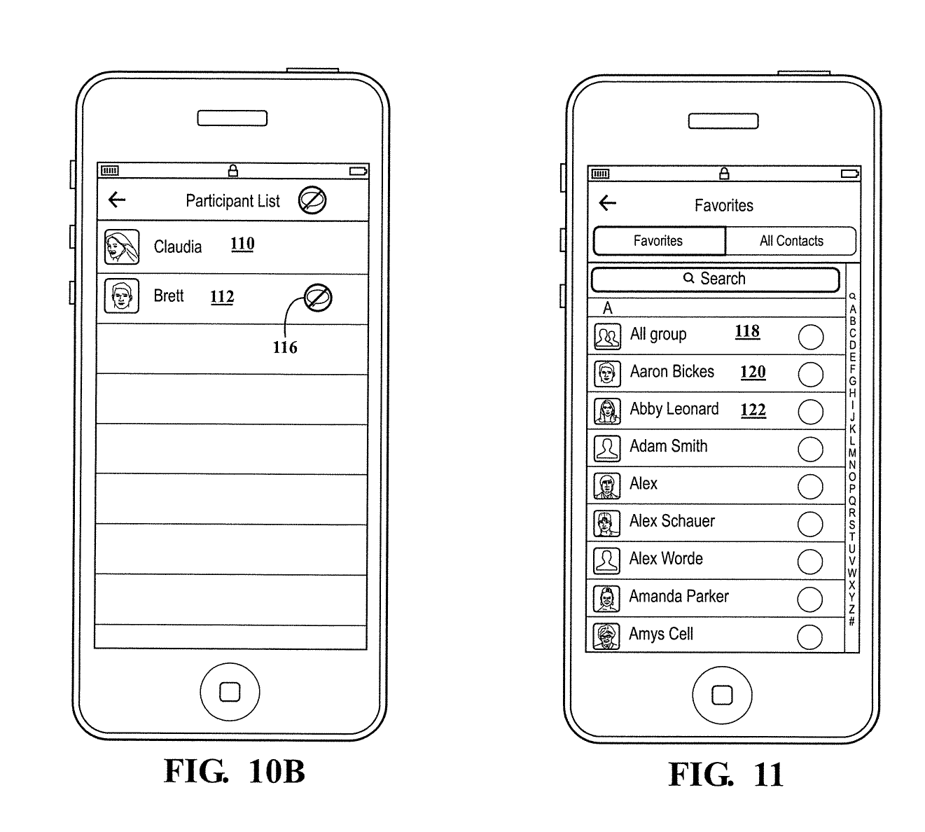

FIGS. 10A and 10B are group and participant list screen, see participants 110 and 112. In this fashion, and upon a guessing message being received, the user will be able to view it and to see who else the message was sent to, such as further clicking on the group icon 114 in FIG. 10A, after which the participant list 110, 112, et seq. appears. A further icon, such including but not being limited in form to a message bubble with a cross out sign such as shown at 116, will appear next to each other users name that the indicated user is not connected with.

In the event that icon 116 is clicked or otherwise accessed, the user is then taken to a privacy policy screen display page (not shown), such including such statements as “This Privacy Info is to Inform you of the data that is used and collected by GuessMessage, LLC” and “In this GuessMessage, these users will NOT receive your responses and you will NOT receive their responses. If you would like to see each other's responses, please add them to your favorites.”

A similar group message screen display such as is previously shown in FIG. 5 can be accessed once a response option has been selected by the user, who can now choose the attachments they wish to response with (again including any or all of text 58, picture 60 and video 62 inputs). As also previously indicated, users will have the option to take a video or picture from within the app (such as using the smartphone or tablet as controlled by the operating software) or to upload an existing picture or video from the storage of the computer processor device.

FIG. 11 is an illustration of a favorites screen display, see field 117, and which are represented by people or groups of people 118, 120, 122, et seq, who you have added within the application software and in addition to additional user groups created as distribution lists. All contacts designation field 124 is also depicted and accesses all contacts saved within the memory of the device (e.g. smartphone).

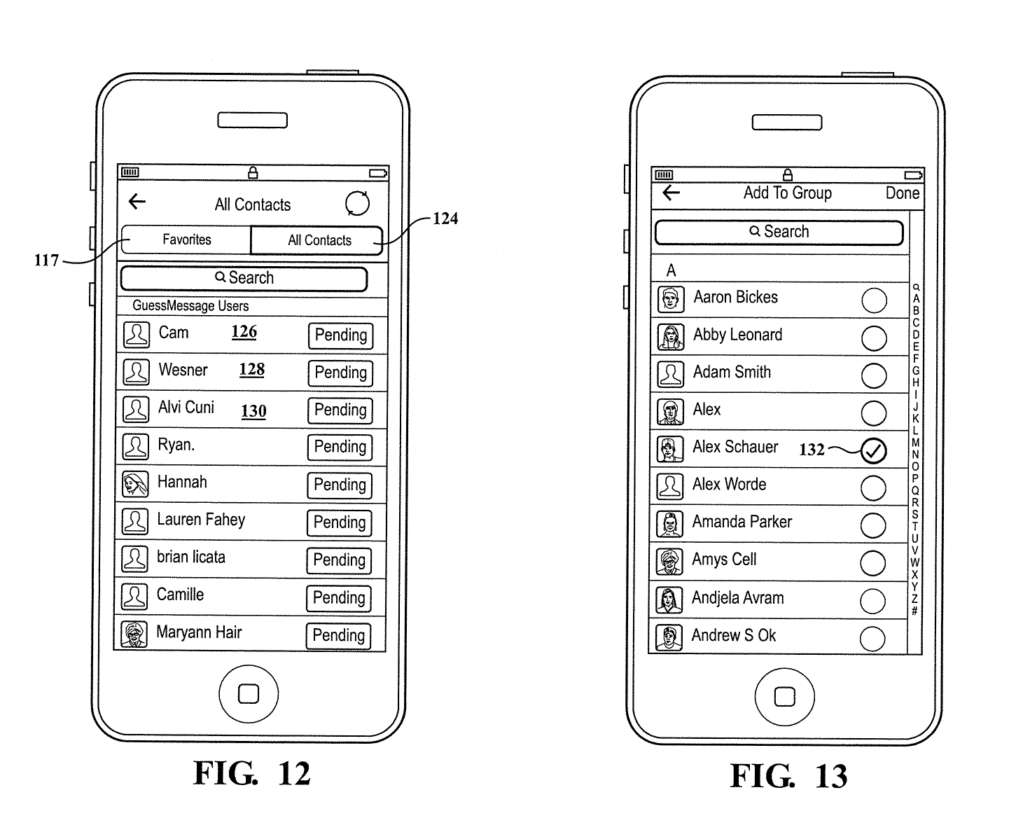

FIG. 12 is an all contacts screen display similar to the favorites screen of FIG. 11 and which is accessed by clicking on field 124. Functionality associated with this screen display includes the ability to display the various users, see at 126, 128, 130, et. seq., in the form of existing contacts who are invited to download the system software and joint, as well as others which are pending the designated user's request to be added as participants (these further defined as those waiting to be added and who may have already downloaded such as the mobile operating application or other software which incorporates the system).

Additional functionality associated with the all contacts screen includes an invite members field and which can include utilizing existing functionality associated with the smartphone operating software for sending an SMS message to the selected user. An alert screen display (not shown) may also be provided and such as which can warn when additional fees and charges may apply.

Other functionality can include selecting and adding members within a defined group or multiple groups of users, see FIG. 13, and such as whom can be listed alphabetically in a favorites listing (see check mark 132 for selected user). Another related tangential screen display (not shown) provides for clicking on a user from your favorites list which forwards to that participant's profile page. At this point, the user can call or text the other user (such as utilizing existing operating software associated with the phone) or blocking the selected user.

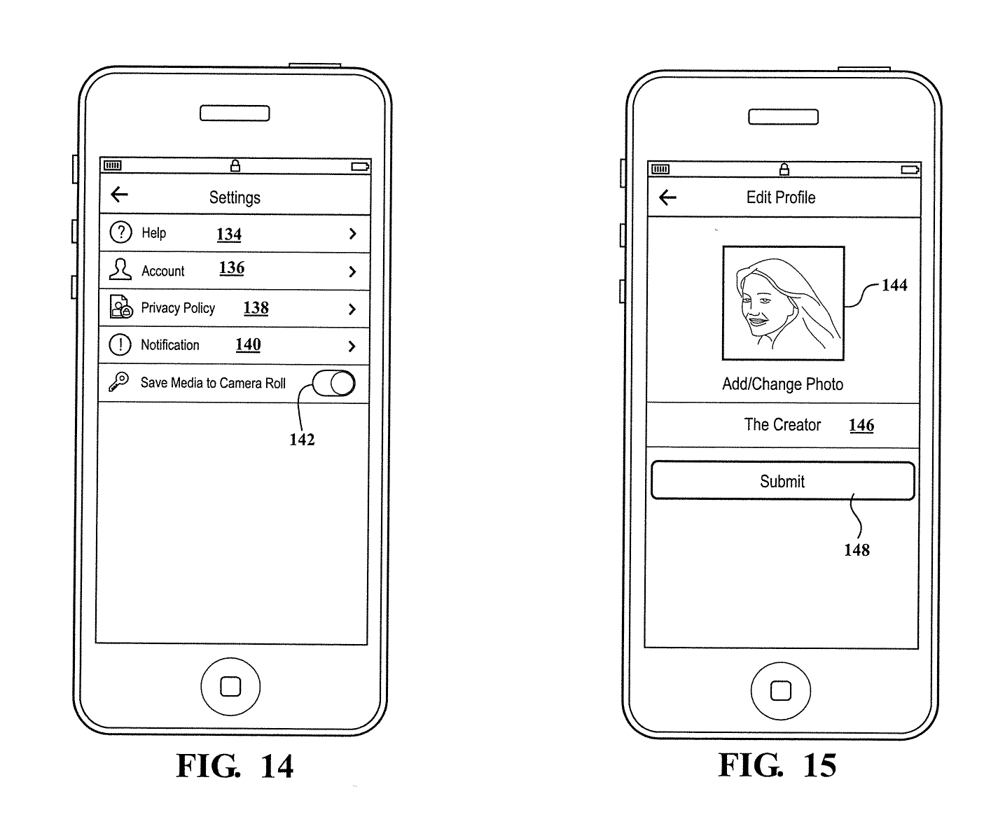

FIG. 14 is a settings screen display which is navigable from the home page display (icon 24 in FIG. 2). The settings page allows the user to adjust their particular settings according to individual needs and the manner in which they use the application. Such includes fields for each of Help 134, Account 136, Privacy Policy 138, Notification 140 and Save Media to Camera Roll 142.

FIG. 15 is an edit profile screen display which is accessed upon tapping (e.g. touch screen interface) or clicking on Account field 136 in FIG. 14 and which includes Add/Change Photo field 144, title field 146 and submit button 148. As previously described, a privacy policy screen is accessed upon clicking or tapping on field 138 in FIG. 14 and takes the user to a page which provides the most currently updated policy regarding user privacy in regards to use of the system.

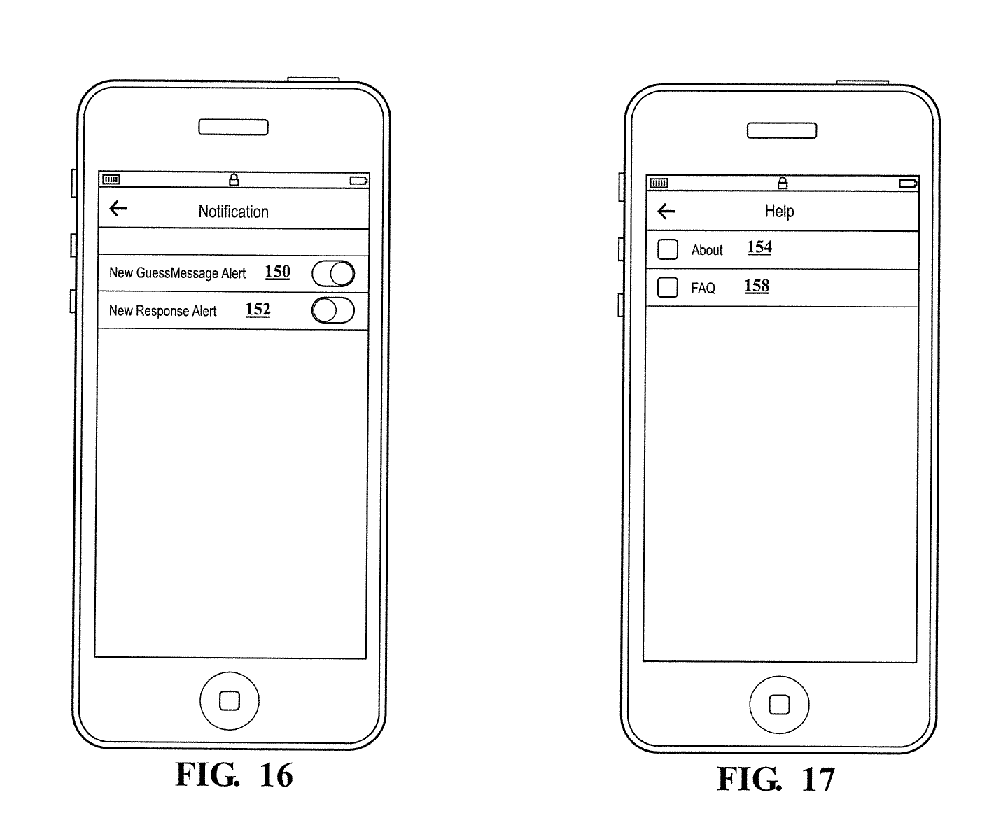

FIG. 16 is a notification screen display (resulting from tapping or clicking on field 140 in FIG. 14 settings screen) and in which message notifications, these including New Message Alert 150 or New Responses Alert 152 can be set for popups, tones and vibrations. Special notification settings also allow the users to activate or deactivate either new messages with initial starter questions and/or new responses.

FIG. 17 is a help screen display (see field 134 in FIG. 14) with About 154 and FAQ (frequently asked questions) 156 fields regarding the mobile application/system and computer writeable medium. The help screen display also leads to a series of screens that describe the features and functionality of the application.

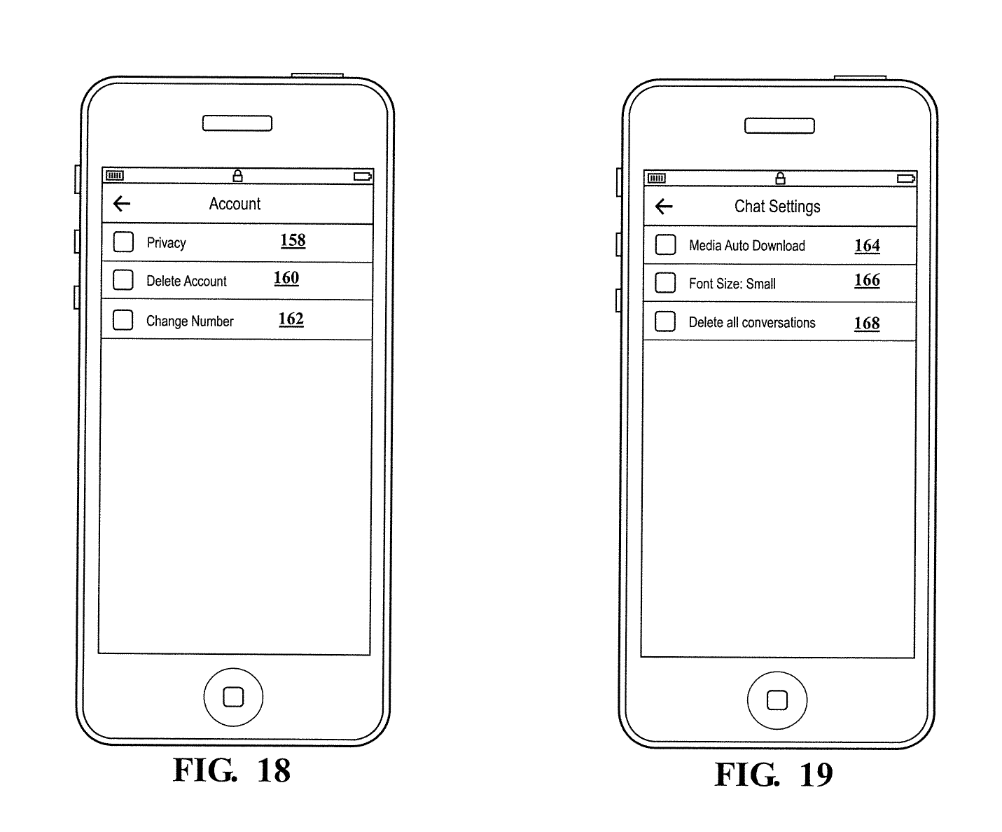

FIG. 18 is a privacy and settings screen display including fields for setting Privacy 158, Deleting Account 160 and Change Phone Number 162 on the account. Finally, FIG. 19 is a media auto download screen display which automatically downloads any media that is sent to a user within a message query or statement. Indicated are Media Auto Download field 164, Font Size field 166 and Delete all conversations field 168.

Additional functionality includes the ability to send user requests to add to the application. This includes both the user name and existing contact name to appear (or that individual's phone number), such eliminating instances of confusion with the correspondence of user names and people. Also disclosed is potential of interface-ability of the (commercially identified GuessMessage) mobile application of the present invention with existing and popular social media sites and programs, namely include Facebook®, Twitter®, Tumblr®, Linked In® or other suitable platform, and with which the present mobile application can be modified to function such as through the incorporation of additional subroutines or other code to facilitate cross interface-ability.

A computer writeable medium is also disclosed for use with a social media based messaging and entertainment system and which includes, at a minimum, a software program presenting a plurality of secure user enterable fields in a first subroutine for creating a query based message or viewing a previously created message or response and a second subroutine for directing to a targeted group of individuals the message or response. The first subroutine may also include a subset screen display including a plurality of entry fields for adding any one or more of text, pictorial or video inputs to the message or response.

Other features include a third subroutine for linking the program to an existing social media platform, with reference further again being made to the operational protocols listed in FIGS. 10-38. Along these lines, and without limitation, also provided is the ability to input a rating feature in cooperation with any created or responded query message. The message outgoing (or response) subroutine also incorporates customization fields as to the audience for receiving the query message, such as which can be directed to an original sender only or to a wider audience. Another customizable feature would allow for group competitions within the query message with possible tangible prizes.

Having described my invention, other and additional preferred embodiments will become apparent to those skilled in the art to which it pertains, and without deviating from the scope of the appended claims:

I claim:

1. A non-transitory computer writeable medium for use with a social media based messaging and entertainment system incorporated into a processor driven device with input and audio/visual output features, said computer writeable medium comprising:
a software program presenting on the processor input/output device a plurality of secure user enterable fields in a first subroutine for creating a query based message or viewing a previously created message or response;
a second subroutine for directing to a targeted group of individuals the message or response; and
a third subroutine for inputting a rating feature in cooperation with any created or responded query message.

2. The computer writeable medium of claim 1, said first subroutine further comprising a subset screen display including a plurality of entry fields for adding any one or more of text, pictorial or video inputs to the message or response.

3. The computer writeable medium of claim 1, further comprising a further subroutine for linking the program to an existing social media platform.

4. The computer writeable medium of claim 1, said second subroutine further comprising respond only to sender or respond to all fields.

5. The computer writeable medium of claim 1, further comprising a notification subroutine for new messages or responses.

6. The computer writeable medium of claim 1, further comprising a further subroutine for displaying most recent responses in a descending order on a visual output display associated with the processor driven device.

7. A social media based messaging and entertainment system, comprising:
a plurality of processor driven devices, each including input and audio/visual output display features;
a software program incorporated into the processor device and including a plurality of enterable fields for composing and responding to query based messages including any of text, pictorial, video or other audiovisual inputs.

8. The system as described in claim 7, the software program further comprising any of a browser supported website or a mobile operating system supported application configured for linking together any number of the processor driven devices.
